(19) United States
(12) Patent Application Publication
(10) Pub. No.: US 2005/0204900 A1
(43) Pub. Date: Sep. 22, 2005

(54) Note collection utility

(75) Inventor: David Alan Burton, Raleigh, NC (US)

Correspondence Address: THE ECLIPSE GROUP, 10453 RAINTREE LANE, NORTHRIDGE, CA, 91326, US

(73) Assignee: EasyNotes, LLC, Raleigh, NC (US)

(21) Appl. No.: 11/082,343

(22) Filed: Mar. 17, 2005

Related U.S. Application Data
(60) Provisional application No. 60/553,843, filed on Mar. 17, 2004.

(51) Int. Cl. G10G 3/04; G10H 1/00

(52) U.S. Cl. 84/600

(57) ABSTRACT

The present invention is directed to computer software for a note collection utility that satisfies the need for a utility to facilitate the creation and maintenance of easily accessed tools to create notes regarding certain types of observations or transactions in a highly efficient and reliable way. The notes are passed to a clinical note program application without modifying the default behavior of that software. In a preferred embodiment of the present invention, a toolbar for a note collection utility is placed adjacent to a third party information collection software application that the observer uses to collect and store notes and other information.

### NOTE COLLECTION UTILITY

This document claims priority to U.S. Provisional Application No. 60/553,843 filed Mar. 17, 2004 and incorporates that application including its three appendixes by reference.

### BACKGROUND OF THE INVENTION

Technical Field

This invention is in the field of computer software and related methods. More specifically, this invention is in the field of computer software and related methods designed to facilitate input of structured notes into a computer application. One particular use of this invention lies in the area of health care, where there is a need for a health care provider to record specific information into clinical notes regarding observations or interactions with a patient.

Computer software applications to record data to create a permanent record of an event or an interaction are well known. Such software typically includes some sort of unique identifier for the entity of interest (usually the subject or object of the interaction). One class of examples of entities of interest is patients of medical providers (e.g. dentists, doctors, veterinarians . . . ) where the medical service provider wishes to record information about a particular transaction such as a visit from the patient. In addition to storing certain general fields with each transaction such as the patients' temperature, weight, and insurance information, there is often a desire to record specific types of information that varies from transaction to transaction. A generalist that sees a patient with high blood pressure and then sees one for a wart on the patients thumb will need to record different types of facts (blood pressure and possibly level of agitation for the high blood pressure patient but location, size, and nature of wart for the wart patient).

When the range of events to record is extremely high, then free form text fields provide an adequate solution as this emulates the traditional form of taking notes with paper and pencil. At the other end of the spectrum, if the range of events to record is very narrow such as a nurse gathering required information before giving a flu shot, then a highly formatted form that asks for specific information in a specific order is appropriate. If there is likely to be sufficient volume of this particular transaction, then the provider of the software application will add such a form as an input screen, or the management of the medical provider organization will see that the long term benefits of having such an input screen justify the expense of asking for a programmer to modify the software application to include such a screen.

What has not been well addressed is the intermediate case of frequent but not uniform needs to record certain types of information along with context providing text into a transaction note. Thus, the prior art has not adequately addressed the needs of those who frequently gather and input the same type of information in clusters. For example, a dermatologist may not record information about a wart with every patient visit, but will likely do so several times a week if not several times a day. Automating or semi-automating the process of recording notes about a patient with a wart would only expedite a small percentage of the dermatologist's transactions as the dermatologist has a number of situations that are frequently part of her practice.

Problems with the Prior Art options

A) Pen on Paper Method

One option is to write notes and have these added to a paper file. This option has the following disadvantages: 1) Time consuming; 2) Difficult to read and understand later; 3) Cumbersome and messy; 4) Need space to store all of the charts (and space is expensive); 5) Employees must spend time filing and there is the risk that some notes may not adequately identify the patient or session and thus be lost or misfiled; 6) the entire chart can be lost and would not have an electronic backup; 7) Not very HIPPA compliant; and 8) paper notes can not be searched electronically. The HIPPA point merits some amplification. HIPPA is the Health Information Privacy Protection Act which restricts access to medical information to those with a need to access the information. Paper notes are pose HIPPA problems as the physical note (even those created through the use of a computer program then printed) is susceptible to being read by those without a need to do so as the note is created, possibly photocopied, placed in a bin for filing, and eventually filed. In contrast a note in a computerized document that stays in computer memory (and is not printed for filing) can be safeguarded from authorized access.

B) Using a keyboard to type notes

A second option is to use a keyboard to type the notes into the textbox of the clinical notes program. The disadvantages are that 1) Not everyone knows how to type; 2) Extremely time consuming and slow (for example: A hygienist can take as much as 7 minutes or more to type her notes for a single patient session); and 3) Presents problem with infection control as the clinician must move both hands onto the keyboard while working with the patient thus increasing the risk of cross patient contamination. With respect to cross contamination, the risk is there with most input devices but a mouse or light pen can be used with a protective cover that is switched between patients. It is difficult to use a keyboard with a protective cover and the nature of most keyboards is that the keyboards have small moving parts with many nooks and crannies that are difficult to clean, especially since cleaning liquids can damage some keyboards.

C) Transcribing Dictated Notes

Another option is to use a dictation machine and have the notes transcribed afterwards. This method has the following disadvantages: 1) Requires investment in dictation hardware; 2) Expensive to pay transcriptionists 3) Delay in obtaining final documents; 4) Time consuming, sometimes the time with the patient can be expedited by waiting to dictate at the end of the day but this requires staying after work to dictate your notes; 5) Creating paper transcriptions raises the same issues discussed above with paper notes and charts; and 6) Also posed potential HIPPA compliance issues as the transcribed note must be physically routed from person to person in the office.

D) Auto-note

The prior art includes a concept known as an auto-note. These prior art notes were mapped with one note per procedure code within the clinical software. As a procedure is marked as completed, an auto-note memorializing the administration of the procedure is added to the clinical notes in lieu of just putting the procedure code. This is in contrast with the notes possible under the present invention which allow for the partial automation of what are sometimes called SOAP notes (Subjective, Objective, Assessment & Plan). The details in SOAP notes vary from patient to patient and this is where relevant facts and decisions can be captured in notes so that the notes convey why the patient was seeking treatment (such as the symptoms) and other patient comments, the diagnosis, and details of the treatment plan including proposed actions for after this clinical session.

As with most clinical notes, a system with auto-note will allow the clinician to access the note and edit it. Thus, it would be possible to augment information about the procedures performed with additional information about why the patient was seeking treatment, the diagnosis, treatment alternatives, and future action items just as it would be with a system that required the clinician to key in all the information without any assistance from auto-note. As with any keyboard intensive solution, there are potential problems with infection control

E) Voice Recognition

A clinical notes program that uses voice recognition is another potential solution but this solution has the following disadvantage 1) Problems with voice recognition software leads clinicians to conclude that the software doesn't work, or at best it is unreliable as it only works “sometimes”; 2) Cumbersome wearing a voice recognition headset along with glasses and masks; 3) Requires a lot of talking and a lot of training; 4) Expensive investment; 5) Doesn't work with noisy backgrounds; 6) Clinician can be easily interrupted by staff and lose train of thought; 7) Presents problems with office turnover, must retrain with new voices of new employees; and 8) Patients can hear what you are saying about them if you are dictating notes in the operatory; problem is compounded with open office layouts which allow the clinician such as a dentist to move between patients in a large open room.

Thus, there is a need for a tool to partially automate and preferably customize the collection of facts and the creation of notes for inserting in the pre-existing software applications that contain text fields for entry of such information.

Portions of the present invention address deficits in the prior art and one or more of the following objectives:
To provide an improved method of writing structured notes into a text field in an application.
To save the observer's time by partially automating the task of writing the notes concerning a specific class of event or transaction.
To give the observer the ability to customize a sequence questions to be addressed in a specific note or portion of a note.
To enable the observer to customize the content of pop-up question screens that are used as prompts to obtain information used in the semi-automated notes.
To enable the observer to customize the selection and sequence of pop-up question screens that are used as prompts to obtain information used in the semi-automated notes.
To enable the observer to create note text templates that combine standard reporting phrases and valued collected from input screens to allow the observer to populate a note from a template and insert that populated note into an application thus saving time and keystrokes each time the observer wishes to insert that type of formatted note into the application.
To increase the speed and accuracy of note collection from an observer to records in an application, thus reducing the incentive to accept the disadvantages of dictation to capture information.
To allow an observer to create, maintain, and modify a library of note templates comprising one or more input question and a text string to be inserted in a text field of a computer application.
To allow the observer to create, maintain, and modify the library of note templates without having to obtain the services of an application programmer to integrate the note template with the specific application.
To allow each observer to tailor an initial set of note templates to the observer's specific needs and style thus avoiding the “cookie cutter” inherent in commercial application software that attempts to meet the needs of many somewhat similarly situated observers.
To allow the answers input by the observer to be saved in memory pending completion of the sequence of questions for that particular note template so that a coherent note can be created at the completion of the questions sequence and input into the text field of the computer application.
To increase the efficiency of note writing processes by allowing question sequences that are apt to be used again and again by the observer to be converted into a note template and thus saving the observer from the drudgery of typing the same text over and over again.
To allow the observer to preview the output from a note template before inputting it into the text field of the computer application to detect any aspects needing adjustment before insertion.
To provide one or more of the above advantages through use of a toolbar located on a computer screen but outside of the portion of the screen allocated to the application to ultimately receive the content of the formatted note.
To provide one or more of the above advantages to create and place formatted notes into a text field of clinical note program without coordination or integration with the source code of the clinical note program.

These and other advantages of the present invention are apparent from the drawings and the detailed description that follows. The above-referenced advantages may be achieved individually and/or in combination, and it is not intended that the present invention be construed as requiring two or more of the advantages to be combined unless expressly required by the claims attached that follow.

### BRIEF SUMMARY OF DISCLOSURE

The present invention is directed to computer software for a note collection utility that satisfies the need for a utility to facilitate the creation and maintenance of easily accessed tools to create notes regarding certain types of observations or transactions in a highly efficient and reliable way. In a preferred embodiment of the present invention, a toolbar for a note collection utility is placed adjacent to a third party information collection software application that the observer uses to collect and store notes and other information. The note collection utility toolbar has a series of buttons arranged in tabs. Clicking on a button for a dynamic note initiates a sequence of queries to obtain the relevant facts for a particular type of observation or transaction and then passes a note formatted to include the facts and binder text that provides context to the third party note collecting software application. Clicking on a button for a static note causes a text string without variables to be passes to the note collection software. An example of a static note is the documentation that a particular instruction or warning was given from a health care provider to a patient. In the preferred embodiment, the user of the note collection utility can create, delete, and edit toolbars, tabs, buttons, and the static or dynamic notes associated with the buttons.

The present invention can be implemented in a variety of embodiments. One commercial embodiment is a software program known as Easy Notes Pro is noted to have the following advantages over the other options open to dentists. The advantages are summarized here but are put into context by the detailed description that follows.

A) Extremely fast at writing clinical notes.

B) In many situations the notes can be sufficiently customized so that the system can be operated without typing after initial setup and customization.

C) Comptemporaneously captures and writes detailed explicit clinical notes that capture important information or milestones from start to finish of patient's visit, not just when a procedure is completed.

D) Requires very little investment (because it is an add-on and not a replacement to the clinical notes software).

E) Does not requires special voice recognition hardware, many dental clinical workstations already use a light pen and virtually all computers have some sort of x-y navigation tool (mouse, tablet computer pen, digitizer, et cetera).

F) Allows complete customization of the note text and dialog boxes by the end-user without having to pay for a programmer to make the modifications. Different clinicians in the same office have the ability to modify both the form of the note and the information input sequence to create the note.

G) Reduces HIPPA compliance issues as the note system does not have to generate paper notes which need to be handled and eventually stored.

H) Decreases risk of cross contamination as there is zero to minimal use of the keyboard after the toolbar has been customized and the notes are adapted to capture the information deemed necessary to document actions in a particular practice. Input devices such as computer mouse, digitizer pad, touch screen, and light pens are easier to keep clean—especially for small devices that can be used within protective covers that can be swapped out for each patient.

I) Lowers risk management by providing improved detailed and legible notes (including legal defense, as the use of reminder boxes in the note creation process forces the clinician to acknowledge giving a set of specific instructions to the patient, asking a patient for certain information, or simply reminding the clinician to do or check something before proceeding).

J) Versatile. Systems in accordance with the present invention can be used by entire office without special training and the system allows the merger of the clinical and the administrative parts of the practice as it supports the insertion of administrative notes into the record such as failing to show for an appointment or a treatment plan selection made during a conference away from the operatory.

K) It works without the problems of voice recognition software, and the pre-scripted notes would be better than voice recognition where you are trying to think of what to say, pausing, then adding to the note, pausing, being interrupted by staff, pausing, again and again.

L) Avoids need for clinician to repeatedly provide the same boilerplate text such as would be required with other modes of input such as voice recognition.

M) The program is multi-tasking between operatories (each person's own toolbar) and multi-tasking within a multi-person practice. The customized toolbars can be customized to the liking each person or customized for each practice so that every hygienist uses the same toolbar. The toolbars can be stored locally at each workstation (which may improved the response time) or accessed across a network from a central repository.

N) The notes generated with what appears to be typed text are easily read, which is not true of many clinician's handwritten notes.

### BRIEF DESCRIPTION OF THE DRAWINGS

FIG. 1 is a representation of the various components of a computer in accordance with the prior art.

FIG. 2 shows the environment for the present invention with observer 204 recording clusters of facts for certain types of transactions in a computer 100.

FIG. 3 shows a screen shot of both the clinical notes program 304 and the linked toolbar 308 from the note collection utility.

FIG. 4 shows one step in the creation of a particular note using the note collection utility, more specifically a dialog box to receive input on the specific tooth being discussed.

FIG. 5 shows a dynamic note 504 placed in a textbox of the clinical notes program 304

FIG. 6 shows the process of opting to edit the process that created the dynamic note shown in FIG. 5.

FIG. 7 shows the edit step for editing the process that lead to the creation of the note shown in FIG. 5.

FIG. 8 shows three dialog boxes used to receive input used in the process to create a note regarding tooth decay.

FIG. 9 shows the screen display after the modification of the order of appearance of the first two dialog boxes.

FIG. 10 shows a screen display scrolled to the right to show a portion of the second dialog box and the two reminder dialog boxes (812 and 1004).

FIG. 11 shows a static note 1104 inserted into a textbox for the clinical notes software.

### DETAILED DESCRIPTION OF THE DISCLOSED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

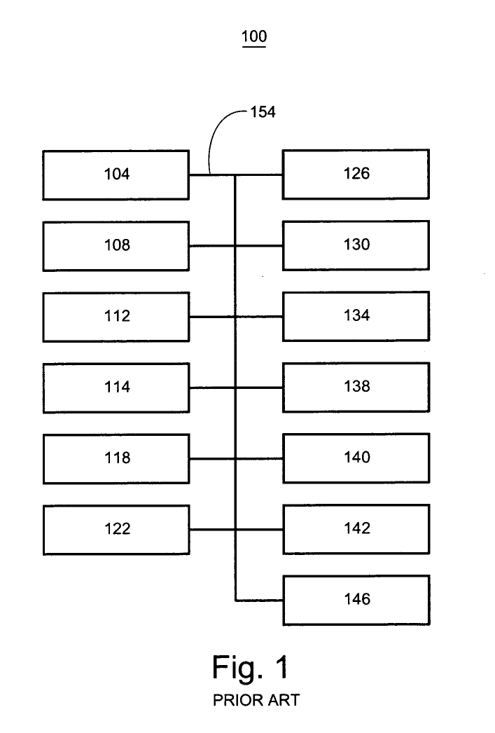

Computer systems such as personal computers are known in the art can be represented generically by FIG. 1. Such a system 100 will comprise a number of separate pieces but can be diagrammed as follows:

104 is an I/O Controller. An Input Output Controller works with the CPU for handling certain aspects of interactions with input/output devices.

108 is a DMA controller to allow direct communication between certain peripherals and RAM.

112 is the Central Processor Unit (CPU or Microprocessor). The CPU executes instructions and manipulates data.

114 is the Clock. The clock provides the one or more clock signals used by other components.

118 is the RAM (Random Access Memory) which is used for temporary memory when executing software.

122 is the ROM (Read Only Memory) which contains permanent memory such as start up instructions for the CPU.

126 is a Mass Storage Device. Most computers have one or more mass storage devices such as hard drives that store programs and data.

130 is a Media Drive. Most computers have one or more media drives such as CD drives or disc drives which can read programs and data from removable media. Many of these drives can also write to removable media.

134 is a Display. Most computers have one or more displays that provide a means for displaying text or graphics.

138 is an Input Device. Most computers have one or more input devices such as keyboards, computer mouse, touch pad, touch screen, light pen, digitizer tablet, or joy stick. Most computers have more than one input device such as a keyboard and a mouse.

140 is an Input Buffer which receives the input from the input device and holds it for subsequent access by the operating system or computer application programs operating on the computer or in data communication with the computer.

142 is a Network Connection. Many computers have one or more network connections. The network connection may include a specialized card such as a NIC card (network interface card), or a wireless card to enable a particular type of wireless connection such as Bluetooth or one of the versions of 802.11.

146 is a Printer. Most computers have some access to a printer or other output device that produces output on paper. These include printers, plotters, and bar code printers. Some computers access printers through the network connection.

154 represents the buses. The various components in the computer are connected by a set of buses that carry data, control signals, and addresses. As the subject matter of this patent does not involve an improvement to computer buses, the buses are shown in an over simplified manner to avoid unnecessary clutter.

Those of ordinary skill in the art will recognize that FIG. 1 does not capture all of the subcomponents necessary to operate a computer 100 (no power supply for example). FIG. 1 does not show all possible variations of computers as certain elements can be combined together such as combining the clock and the CPU. Further, a computer may have more elements than are shown in FIG. 1 including multiple instances of components shown in FIG. 1 and additional elements not shown in FIG. 1. Finally a computer can be configured to be lacking one or more elements shown in FIG. 1. For example a computer can be configured to operate without a DMA controller, or some elements of the computer of FIG. 1 can be removed from the computer, especially if it has access to such components through a network connection.

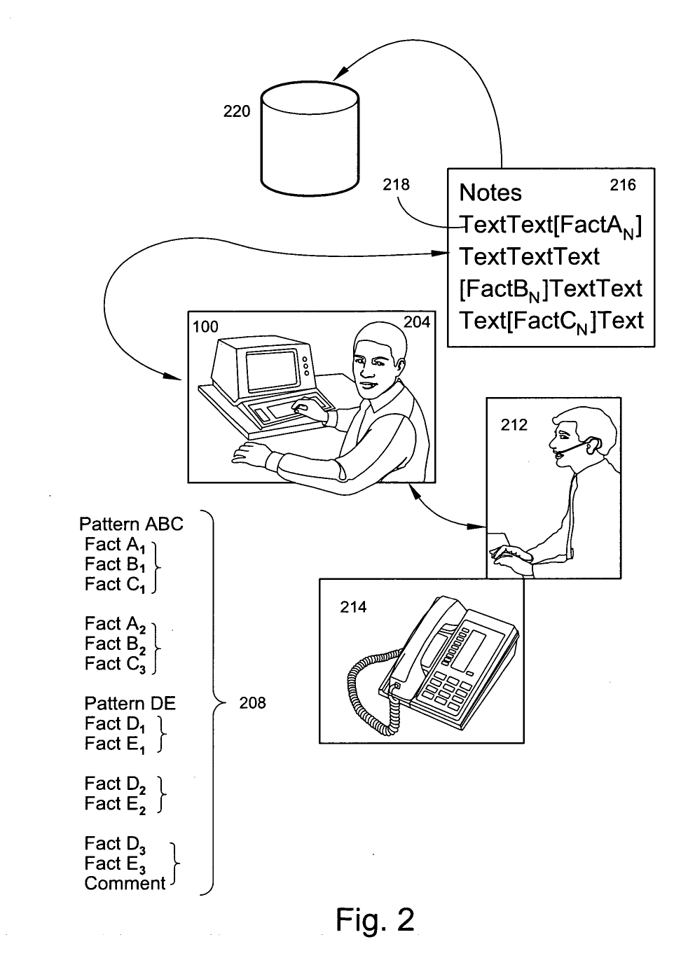

FIG. 2 illustrates the environment of the problem addressed by the present invention. Observer 204 collects information on relevant sets of facts 208 either through direct observation or through a chain of one or more reporters 212. These facts can be input to a computer program operating on the computer 100 through one or more input means such as a keyboard, mouse, microphone connected to a voice recognition software module; touch screen, or other input means known in the art.

A set of related facts will be joined by text strings to form a text note 216. This text note 216 is stored in memory 220 which may be in the computer 100, on suitable media which can be read by computer 100, or remote from the computer 100 but in data communication with the computer through any one of the means known in the art.

As this process is repeated with additional clusters of related facts, the observer is obligated to input virtually the same binder text 218 in note after note to tie together the entered facts and to provide context to the patient-specific facts. This process has several unfortunate consequences. Especially when viewed in the context that frequently, the observer 204 is highly trained and highly compensated so it is particularly desirable to minimize the amount of time consuming and repetitive tasks performed by this observer in order to better utilize the specialized skills and training of the observer.

At bare minimum, the observer 204 is spending a large amount of time in repeatedly typing binder text 218 and inserting the relevant facts. The observer 204 may attempt to reduce the amount of text entered for each cluster of facts by using the observer's own idiosyncratic abbreviations for the text necessary to provide context to the set of facts. These abbreviations may not be standardized across similarly situated observers that all provide notes 216 to the memory 220 such that it is difficult for those who subsequently retrieve the notes 216 to quickly review the notes as the format and abbreviations vary from note to note.

As the number of repetitions of fact gathering and note producing increase, it becomes more likely that some of the notes will fail to contain or accurately convey one or more facts in the relevant fact cluster. This problem of partially incomplete notes can be more common when the observer 204 is working with another party 212 which may interject facts out of sequence, or when the observer is interrupted or otherwise distracted by extraneous stimulus such as a ringing phone 214.

One prior art solution was the preparation of a form to receive a specific pattern of facts for particular context. Thus the use of the form and the structured input fields provide context for the information. These input forms while well adapted to certain transactions with a set of ten or more facts (such as a new patient form at a doctor's office) are not adequate for use in conjunction with application software designed to collect unformatted notes. These notes fields allow observations to be entered with relevant information for review at a later date. The aggregate collection of notes for a given subject (study, patient, machine, etc.) may include a number of clusters of facts of a first pattern, some clusters of facts of a second pattern, and a number of instances of a cluster of facts yet another pattern. The aggregate collection of notes may include additional non-standard observations and commentary to elaborate on the facts in a more common fact cluster.

The creation of a large number of forms, each optimized to collect a short sequence of facts is not the best situation in some contexts as the time needed to locate, load, and then specially move the form to storage may outweigh the savings from the use of the context providing form.

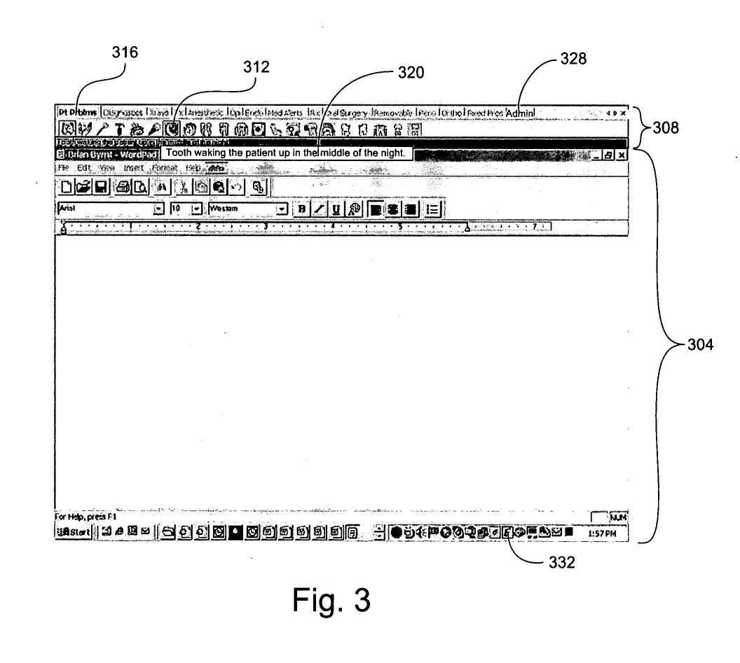

The present invention can be illustrated by a sequence of transactions for one particular observer Ann. For this particular example, Ann is a dentist that wishes to record facts and events from patient interactions into clinical software that Ann has loaded on her computer 100. Screen shots demonstrating some of the steps taken by Ann are provided in FIGS. 3-11. (Additional context can be acquired by viewing help files for one particular implementation of the present invention for use with a particular clinical note program instead of the more basic Word Pad program. These help files appear in Appendix A

Ann loads a note collection utility program on her computer and links the utility to her third party clinical software. The linkage of the utility program to the clinical note program is done through conventional means and preferably without having to modify any of the program files for the clinical note program. An example of a satisfactory strategy for making the linkage can be found in prior art software SmartPad for Microsoft© Windows™ (Release 3.5) by Softblox, Incorporated of Atlanta, Ga. or by Aimstools by Aimsoft Development Corporation of Carson City Nev. (http://www.aimsoft.com/aimtools.html). Ann chooses to have the toolbar from the note collection utility open each time she opens the clinical note program. (See Section A of the Appendix for one particular implementation of Linking a Toolbar to an application).

In a preferred embodiment the note collection utility program contains a set of different basic tool bars created with different clinical focus. For example in the dental setting there may be a toolbar designed to record notes from a hygienist and a toolbar designed to record notes from a dentist since the range of notes that a hygienist would enter may be less than that of a dentist.

In a preferred embodiment, the selected toolbar from the note collection utility is copied into storage such as the computer's mass storage device 126 so that the copy of the toolbar can be customized without altering the basic toolbar provided with the note collection utility. In a practice with more than one dentist, each dentist could store one or more copies of the dentist toolbar which could be customized by each dentist. An individual dentist could actually have more than one toolbar so that a toolbar could evolve to be particularly convenient for use with pediatric patients and another toolbar for adult patients.

A preferred process for linking the note collection utility to the underlying clinical records program is to drag a “target” to the particular window of the clinical notes program that will receive the output of the note collection utility. This eliminates the need for the end user to know the name of that particular window. Typically, the link would be ongoing so that every time that particular window is opened in that clinical notes program the note collection utility would open that particular toolbar.

Ann goes to lunch and closes both the note collection utility and the third party clinical notes software. Turning now to FIG. 3, after lunch Ann reopens the clinical note program 304 and the linked toolbar 308 from the note collection utility also opens. The toolbar from the note collection utility is placed by the utility to be adjacent but outside of the region of the display allocated to the clinical note program. To provide context without getting distracted with the details of a feature rich clinical notes package, assume Ann uses WordPad by Microsoft to collect her notes for each patient.

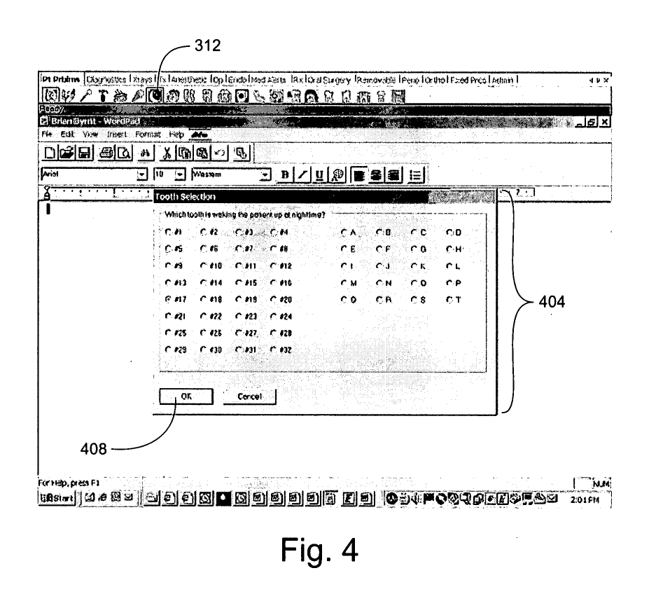

After talking with patient Brian Byrnt, Ann moves her cursor over a button 312 associated with the first tab 316 to obtain a reminder 320 of the context for the note that would be prepared by the routine associated with that particular button. In this case the button 312 handles a note for “tooth waking patient up in the middle of the night”. After actuating button 312, a screen shown in FIG. 4 is presented. Through use of a dialog box 404, Ann indicates that it is tooth 17 that is causing the problem and hits the OK button 408.

After actuating the OK button 408, the note collection utility having all the information needed for this simple dynamic note provides the note to the keyboard buffer maintained by the operating system. In a preferred embodiment, the note collection utility yields the focus of the active window to the clinical note program before passing the dynamic note to the keyboard buffer. By the act of the operating system changing the active window to the clinical note program then the operating system sends the symbols received in the keyboard input buffer to the clinical note program as the normal operation is to pass the keyboard input to the active window.

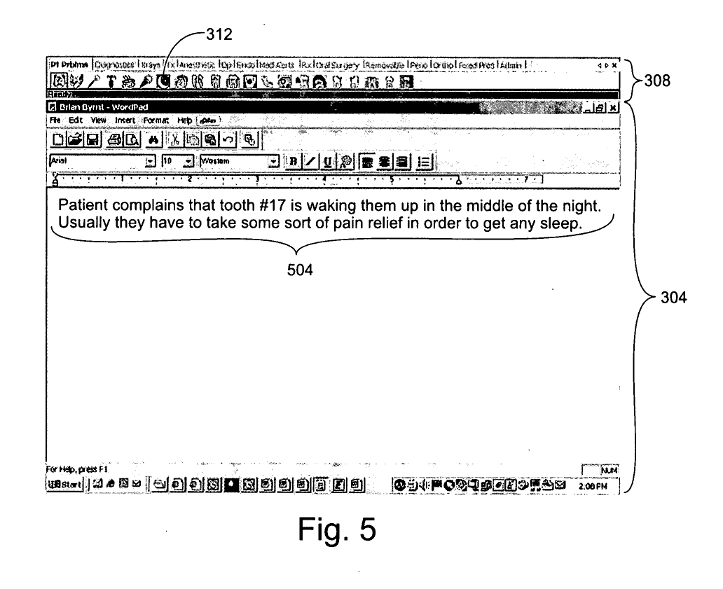

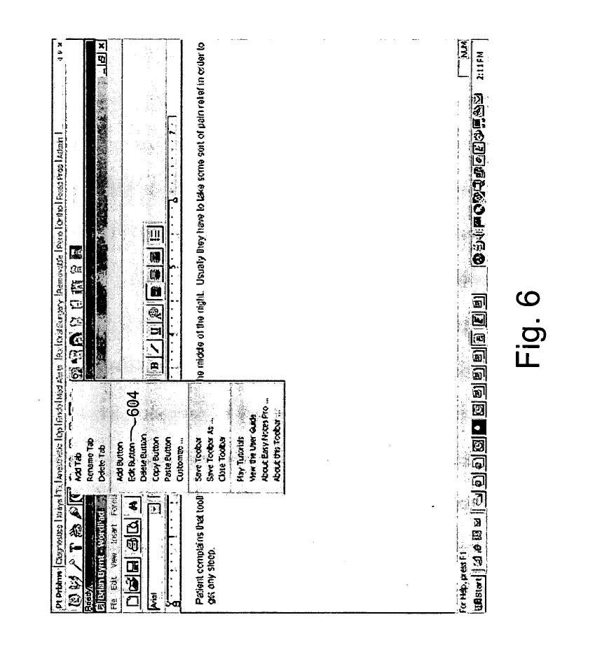

The resulting note 504 appears as shown in FIG. 5. Ann looks at the note and decides that she is not happy with referring to the single patient as a “they”. While she could edit the note now that it is in the clinical note program, Ann moves to edit the content of this binder text by right clicking on the night pain button 312 and selecting the Edit Button choice 604 as shown in FIG. 6.

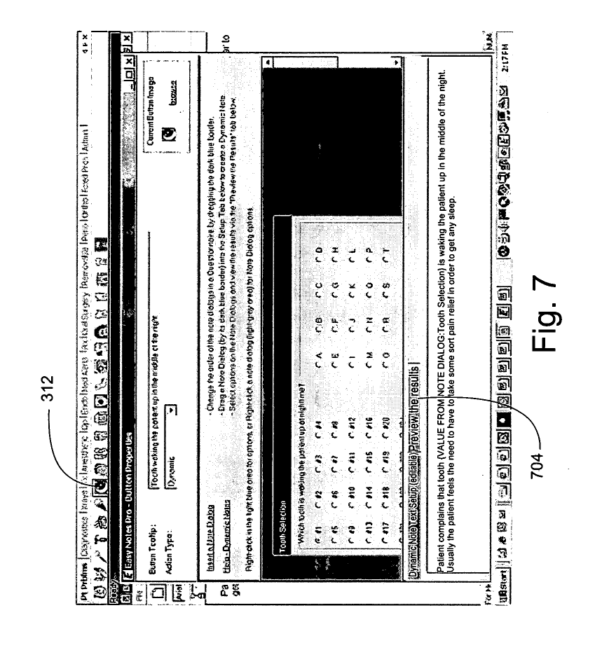

Ann is presented with the properties and the binder text used to provide context to the note as shown in FIG. 7. Ann revised the text including replacing “they” with “the patient”. By actuating the preview button 704, a second note is sent to the active window of the clinical notes program. Satisfied, with the revised note, Ann deletes the previous note. Ann exits the edit function for night pain button 312 and resumes collecting information regarding Brian Byrnt. Ann saves her revised toolbar to keep the changes.

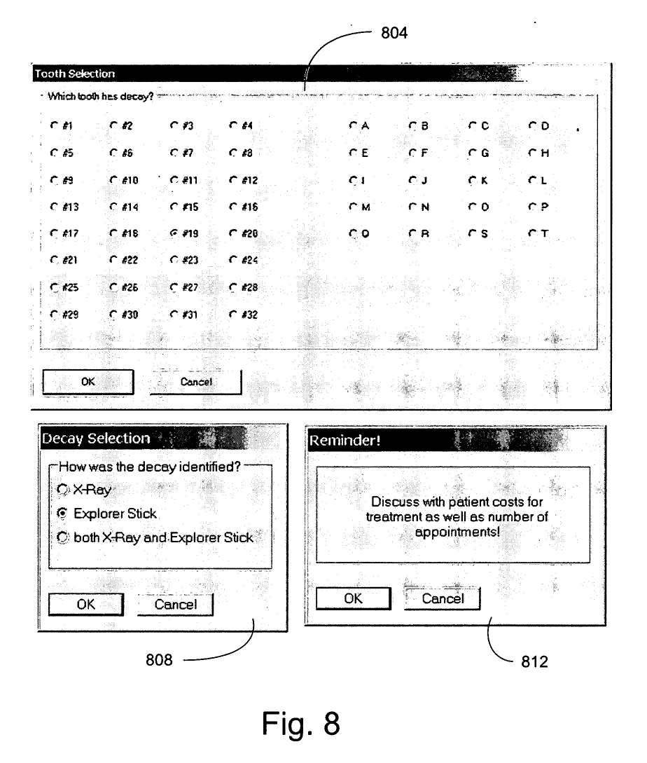

Ann now moves to a tooth decay button (not shown as it is a choice on the Diagnosis tab) to enter a note regarding tooth decay found on another tooth in Brian's mouth. After actuating the tooth decay button, Ann is presented with a series of dialog boxes (shown in FIG. 8) After indicating in the Tooth Selection dialog box 804 that it is tooth number 19, Ann indicates in Decay Selection dialog box 808 how the decay was identified. Ann then receives a reminder dialog box 812 from the tooth decay note routine to discuss specific treatment costs. After acknowledging the receipt of this instruction, the note collection utility provides a series of keystrokes to the keyboard input buffer and these keystrokes are taken by the clinical note program to insert the note into the patient's record.

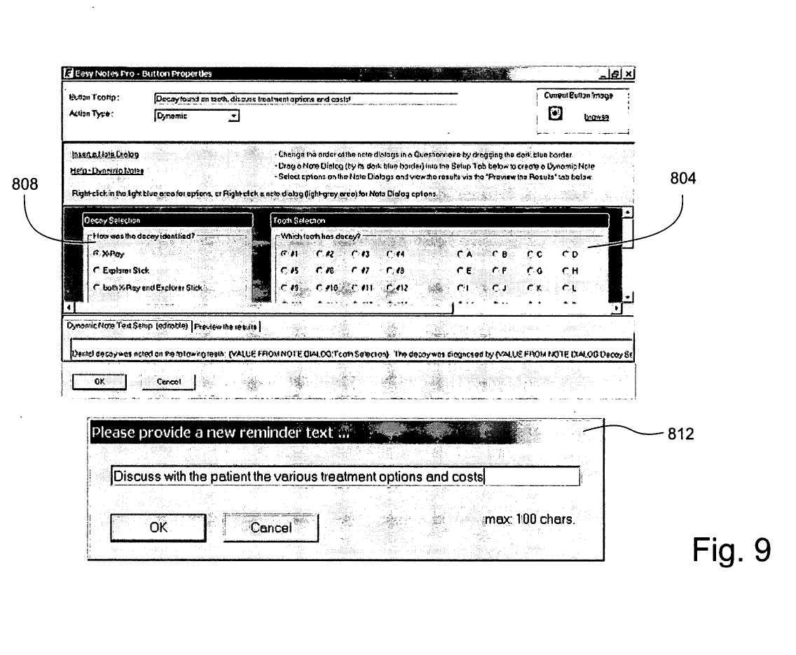

Although Ann likes the format of the note written to the clinical note program, she would prefer to indicate the diagnosis tool first, then the tooth. Ann selects the tooth decay button for editing in the same manner described above. After she drags and drops the second dialog box for decay selection 808 to the front (left) of the tooth selection dialog box 804 to alter the sequence of questions when this button routine is executed, the screen appears as is shown in FIG. 9. Note that this movement did not alter the form of the note as the note receives input from specific dialog boxes rather than first input and second input.

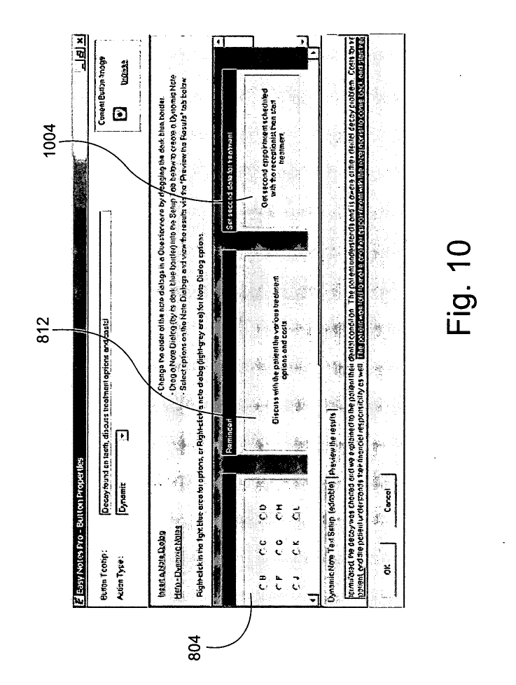

Ann moves to the third dialog box and right clicks on the reminder to alter it. Ann decides to split the reminder into two steps so that she does not skip anything when providing these instructions to the patients. First she edits the text of the current reminder dialog box 812 then adds a second reminder dialog box 1004 to provide the rest of the reminder. Now execution of this button routine will ask her the questions for input in her preferred order and then provide the reminder instructions in two steps. Note that as show in FIG. 10, the reminder text provided to the dentist does not have to be the precise text added to the note.

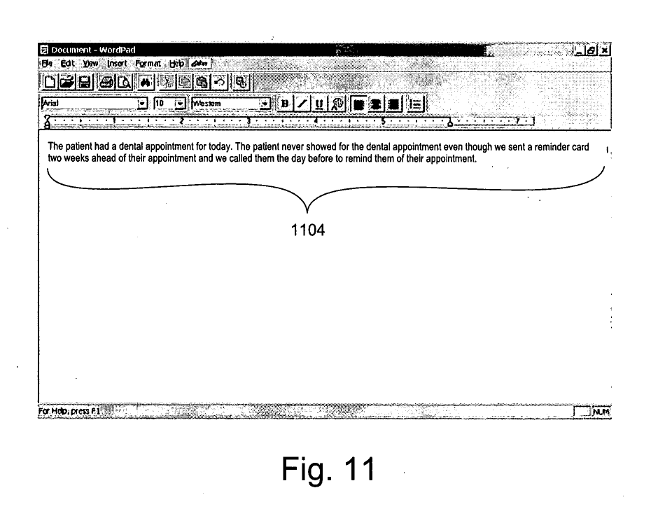

For a later appointment, the patient does not show up. Ann wishes to note this in the patient file. She selects the ADMIN tab (element 328 in FIG. 3) and a button (not shown) for patient did not show up for the appointment. After selecting the patient-did-not-show-up-for-appointment button, and without further input by Ann, a static note 1104 (no variables) is placed in the clinical note program as shown in FIG. 11.

Implementation notes for one implementation are as follows. The present invention can be implemented in Microsoft.NET. The toolbar can be built as a NET assembly that exists in the form of a dll file. The toolbar is linked to the third party application by subclassing the application's window. To minimize the demands on the user to initiate the link, a preferred embodiment calls for the user to indicate to the note collection utility the window with the relevant clinical note program by dropping a target cursor onto the displayed third party application. Using a documented Windows API call, the note collection utility procedure is inserted before the clinical note program procedure.

In an optional feature, the note collection utility can be permanently (until undone) linked to the clinical note program. One implementation of this feature is achieved by an autolistener program implemented as a TSR program (“TSR” stands for “Terminate but Stay Resident). In FIG. 3, an icon 332 for an implementation of the present invention shows as an (“E”) near the bottom right corner of the taskbar on your desktop screen. The autolistener program is loaded into the startup file of the Windows Operating System so it is started with the startup sequence of the computer. The autolistener program “listens” for the program that the note collection utility has been permanently linked to. When the user launches the clinical note program, the autolistener program interprets that command and then initiates the sequence of commands to achieve the same result as manually linking the note collection utility to the clinical note program thus saving the user from the extra steps to link the toolbar to the third party application each time the third party application is launched.

The preferred embodiment does not modify the default behavior of the third party application. The third party application continues to receive all the Windows messages without alteration. The preferred embodiment of the note collection utility does monitor the messages for the window running the clinical note program so that the linked toolbar can be minimized, maximized, restored, and closed as the window with the clinical note program is minimized, maximized, restored, and closed.

In a preferred embodiment, the note collection utility creates a new note in a memory block controlled and owned by the note collection utility. The toolbar with its associated tabs, buttons, and note routines note can be stored as an XML file with a signature added to prevent external tampering (editing through means other than the note collection utility). The operation of a note routine causes a series of symbols to go to the Windows keyboard messaging queue (keyboard input buffer). The effect is that the clinical note program receives the keystrokes from the input buffer as if the keystrokes were manually entered by the user. In the preferred embodiment, this is performed using standard Windows APIs so that the transfer of the keystrokes is accomplished through the use of the operating system. As referenced above, the note collection utility changes the active window within the computer to the window with the clinical note program so that keystrokes received in the keyboard input buffer as passed to the clinical note program.

While another embodiment could make the transfer of a formatted note to the clinical note program through the clipboard utility, this is not an ideal solution since so many programs make use of that utility. If the clipboard program is used, then the note would be pasted to the textbox of the clinical note program either through passing the appropriate keystrokes sequence to the keyboard buffer or by keystrokes provided by the user after the focus has moved to the clinical note program textbox.

Some clinical note program programs have a keystroke sequence such as ALT c or ALT o to move to the end of the free formatted text field. It is only some of the clinical note program that uses these special command keystroke sequences as some other clinical note program with just a text field such as Word or WordPad does not need such a text string to access the note section of the program.

A modification of the present invention is to provide this sequence of command keystrokes to the note collection utility so that notes can be passed with a prefix of the relevant keystroke sequence to indicate input to the free formatted text field. If such as sequence is useful, then the specific sequence for that particular piece of clinical note program would need to be made known to the note collection utility either by explicitly providing the key sequence during the operation to link the computer or by the note collection software knowing the various keystroke sequences used for the commonly used clinical note programs. However passing this sequence of command keystrokes is not necessary as the user of the clinical note program can move the cursor through mouse, tabs, or control characters before initiating a button's note generation sequence.

### ALTERNATIVE EMBODIMENTS

The examples given above show the movement of a note created through use of the note collection utility into a window of the clinical notes program. In order to show the created note, the clinical notes program textbox was left open after the receipt of the note. Some users may prefer this option, especially as they are first using the note collection software and are gaining confidence in it. Operating in this mode, the end user can read each created note before manually closing the textbox in the clinical notes program. The end-user would also be able to modify or expand the notes to capture additional detail. As the end-user has the ability to alter the text of the note or to add additional buttons to the toolbar, over time it is expected that the number of edits made by the end-user will decrease until it is an unusual note that needs to be edited.

Alternatively, end users may become so used to the note collection utility that has evolved to capture their note writing preferences that the vast majority of notes are entered into the system without further modification by the end-user. For such end-users, it would be more efficient to allow an end-user to complete a note generated by the routine associated with one note button and proceed directly to creating the next note based on the routine of another note button. In a preferred embodiment of the present invention the end-user can set a default to either elect to leave the focus of the active window in the textbox of the clinical notes program or close the textbox and return the focus of the active window back to the note collection utility toolbar so that the end-user can quickly start a new note. The end-user can then wait until the end of the session to open the clinical notes program and review all of the notes for that session for accuracy and completeness and make any necessary edits.

The present invention has been disclosed in the context of medical notes taken by a medical service provider. The present invention is not limited to this field and does not rely on any particular aspect of the medical service field beyond the fact that certain types of procedures or interactions are likely to happen with sufficient frequency to merit some effort to automate the process of collecting facts and recording them in a specific way. As the note collection utility can be run with software programs provided by third parties (and obviously could be run as a utility for software provided by the same entity that provided the note collection utility). The only limitation is that the third party software program must be able to receive text input from the keyboard. As a practical matter, this note collection utility is only going to provide value in situations where at least a subset of the notes that are collected are in a predictable format such that partial or full automation of the creation of the notes is possible.

The following table provides a small sample of other analogous situations with a skilled observer collecting information and desiring to quickly and accurately capture the facts and the context of the facts in an electronic note.

| | Observed | |
|---|---|---|
| Observer | entity | Typical transaction |
| Insurance | Damaged car | Note location and severity of various types |
| adjuster | | of damage to a car |
| Mechanic | Jet Engine | Note the specific items that were repaired, |
| | | replaced or inspected on the jet engine. |
| Biologist | Study | Quickly and accurately record details of |
| | subject | one of a number of specific types of |
| | | behavior of interest to the study. |
| System | Server | Note the details of various types of |
| Administrator | | upgrades; repairs; or failures. |
| Help Desk | Caller | Automate the process of collecting |
| | | information about various calls for |
| | | assistance. Note as the types of problems |
| | | for the callers will gradually change over |
| | | time, there is a need to update the |
| | | observation templates to address the |
| | | newest virus or software |
| | | incompatibility problem. |
| Trainer | Weightlifter | Note the relevant details regarding each |
| | | exercise including presence of pain, |
| | | changes in order of performing exercises |
| | | and other facts that would be difficult to |
| | | capture in a mere checklist form. |
| Cosmetologist | Customer | Record hair customer preferences such as |
| | | color preferences, details for hair cut |
| | | preferences; record details of services |
| | | provided such as details on the chemicals |
| | | used and time duration of application so |
| | | that the process can be replicated or |
| | | adjusted as needed in a future visit. |

The examples set forth above are given in context of Microsoft software tools as this is a well known set of tools to those of skill in the art. The scope of the invention is not limited to computers running the enumerated Microsoft tools. Those of ordinary skill in the art will find that these teachings can be ported without undue experimentation to computers running products from other suppliers or operating systems including without limitation products from Apple Computer, Inc. based in Linux or Unix, or other combinations of software as long as there is the ability to run a utility program while also running a note collection program and there is a buffer that receives input to be placed into the active window (or analogous term in that system). The form factor of the screen shots used in this document is from a standard personal computer display. Those of ordinary skill in the art could adapt the teachings of the present invention to use on smaller, perhaps hand held devices capable of receiving and storing text input. This category of smaller devices includes but is not limited to Personal Digital Assistants (PDAs), mobile phones with additional capabilities, and small personal computer devices.

This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Those skilled in the art will recognize that the methods and apparatus of the present invention have many applications and that the present invention is not limited to the specific examples given to promote understanding of the present invention. Moreover, the scope of the present invention covers the range of variations, modifications, and substitutes for the system components described herein, as would be known to those of skill in the art.

One of skill in the art will recognize that alternative embodiments set forth above are not universally mutually exclusive and that in some cases alternative embodiments can be created that implement two or more of the variations described above.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method of creating a note by a user for storing in a memory device associated with a computer system through use of a first computer software application operating on a computer with an operating system, the note describing an observation of a type likely to be noted by a certain type of observer, the observation comprising a fact of a first type and a fact of a second type;
the method comprising:
opening the computer software application and a note collection utility on the computer;
providing input to the computer to select a particular observation template associated with the note collection utility;
responding to a series of prompts to submit to the note collection utility Fact A for the fact of the first type; before submitting Fact B for the fact of the second type;
providing input to the computer to cause the computer software application to receive a note of a first format in a text input field within the computer software application, the note comprising: a text string comprising Fact A, Fact B, and binder text that provides context for the submitted facts; and
providing input to the computer to cause the computer software application to store a representation of the note in the memory device associated with the computer system.

2. The method of claim 1 where the step of providing input to the computer to cause the computer software application to receive a note of a first format in a text input field within the computer software application is performed by submitting the last input requested by the series of prompts for the particular observation template.

3. The method of claim 1 wherein
the step of responding to a series of prompts further includes providing an acknowledgement to a reminder dialog box; and
the note provided to the text input field within the computer software application further comprises text indicating that a certain task was performed as previously acknowledged in the response to the reminder dialog box.

4. The method of claim 3 where the task performed was providing specific information to a third party.

5. The method of claim 3 where the task performed was obtaining specific information from a third party.

6. The method of claim 1 wherein note collection utility causes the note to be stored by passing a set of symbols to emulate keystroke input to the computer operating system; the set of emulated keystrokes are received and processed by the software application program in the same manner as if the keystrokes were provided by the user providing input to an input device associated with the computer.

7. The method of claim 6 where the note collection utility causes the note to be stored in a keyboard input buffer.

8. The method of claim 1 wherein note collection utility causes the note to be stored in memory associated with a clipboard utility so that the note can subsequently be pasted into a textbox of the software application program.

9. The method of claim 1 wherein the note collection utility causes the note to be received in the text input field within the computer software application by passing the note to memory controlled by the computer operating system and accessible to the computer software application and causing the active window of the operating system to switch from the note collection utility to a window in the computer software application.

10. The method of claim 1 further wherein the step of opening the computer software application and the note collection utility on the computer comprises the steps of:
linking the note collection utility to the computer software application;
closing both the note collection utility and the computer software application; and
opening the computer software application and thus opening the linked note collection utility which allocates space on a display screen for the computer for a tool bar associated with the note collection utility, the tool bar positioned outside of the space allocated on the computer display for computer software application.

11. The method of claim 1 further comprising the steps:
modifying the particular observation template to change the sequence of the series of prompts to the prompt for the fact of the second type followed by the prompt for the fact of the first type; the modification to the sequence being completed without altering the format of the note from the first format.

12. The method of claim 1 further comprising the steps:
modifying the text that appears with the prompt for the fact of the first type.

13. The method of claim 1 further comprising the steps:
modifying the binder text in the particular observation template so that subsequent submissions of notes after selection of that particular observation template will comprise a new text string comprising a current set of submitted values for a fact of a first type, and a fact of a second type, along with the modified binder text

14. The method of claim 13 further comprising the step of storing the modified binder text for the particular observation template so that after closing the note collection utility, and subsequently opening the note collection utility, the user can access the modified binder text for the particular observation template without having to repeat the process of modifying the binder text.

15. The method of claim 14 wherein the user can elect to use a set of observation templates provided with the note collection utility or a set of observation templates as previously saved by the user or a set of observation templates previously saved by a different user.

16. The method of claim 1 further comprising the steps of:
providing input to the computer to select a particular static observation with a first static format associated with the note collection utility and to cause a static note of the first static format to be received in the text input field within the computer software application; the static observation containing a text string to note a fact but not containing any variables thus use of this particular static observation does not require input from the user; and
providing input to the computer to cause the computer software application to store a representation of the static note in the memory device associated with the computer system.

17. A method for providing input to a textbox window in a note collection program operating on a computer that is currently running a computer operating system;
opening the note collection program and a note collection utility that operates independently of the note collection program;
accessing the note collection utility so it becomes the active window in the operating system;
selecting a particular note format;
providing a series of at least one fact to create a note comprising binder text and the set of at least one fact;
passing the note to the input buffer used by the note collection program to receive input from the user for placement in a textbox window; and
causing the textbox window of the note collection program to become the active window so that the note is moved from the input buffer to the textbox.

18. The method of claim 17 wherein the step of causing the textbox window of the note collection program to become the active window so that the note is moved from the input buffer to the textbox concludes with the textbox as the active window so that the user can view the newly moved note and the user may edit the note using the tools provided by the note collection software.

19. The method of claim 17 wherein the step of causing the textbox window of the note collection program to become the active window so that the note is moved from the input buffer to the textbox concludes with returning the active window to the note collection utility so that the user can start the process of generating another note rather than viewing the newly moved note in the textbox of the note collection software.

20. The method of claim 17 wherein the steps of:
accessing the note collection utility so it becomes the active window in the operating system;
selecting a particular note format;
providing a series of at least one fact to create a note comprising binder text and the set of at least one fact;
passing the note to the input buffer used by the note collection program to receive input from the user for placement in a textbox window;
causing the textbox window of the note collection program to become the active window so that the note is moved from the input buffer to the textbox; and
are executed without the use of a computer keyboard so as to minimize the risk of cross contamination of patients by a clinician recording notes about interactions with patients.

21. The method of claim 17 where the step of passing the note to the input buffer used by the note collection program includes the act of passing a set of control characters used in the note collection program as input from a user to move to the end of the text in the textbox such that when the note is moved from the input buffer to the textbox that the note is placed after any preexisting text in the textbox.

22. An information processing device configured with instructions to operate by:
loading a note collection utility and a note collection program;
displaying a toolbar for the note collection utility adjacent to the region allocated for the display of the note collection program;
responding to a user selection of a particular note creation button associated with the toolbar by requesting a set of at least one fact input from the user for use in creating a note to be placed in a textbox in the note collection program;
placing a note comprising the set of at least one fact input from the user and binder text in a memory used to contain input from an input device associated with the information processing device; and
changing the focus from the note collection utility to the textbox for the note collection program so that the note is passed from the memory to the textbox.

23. The information processing device of claim 22 wherein the step of loading a note collection utility program and a note collection program is achieved by automatically loading the note collection utility upon receipt of an instruction to load the note collection program.

24. The information processing device of claim 22 wherein the operation is further characterized by:
returning without user input the focus to the note collection utility after the note is passed from the memory to the textbox so the user can select another note creation button to begin the creation of an additional note.

25. The information processing device of claim 22 wherein the displaying of the toolbar from the note collection utility is further characterized by displaying a toolbar previously modified by this particular user such that the toolbar displayed for this particular user is different from the toolbar provided as a default toolbar with the note collection utility.

26. The information processing device of claim 22 wherein the information processing device is configured to operate so that the action of placing the note comprising the set of at least one fact input from the user and binder text in the memory used to contain input from the input device associated with the information processing device includes the act of passing a set of control characters used in the notes collection program as input from a user to move to the end of the text in the textbox such that when the note is moved from the memory to the textbox that the note is placed after any preexisting text in the textbox.
